(19) United States
(12) Patent Application Publication
(10) Pub. No.: US 2020/0233176 A1
(43) Pub. Date: Jul. 23, 2020

(54) CAMERA LENS, LENS MODULE, AND ELECTRONIC DEVICE INCLUDING THE SAME

(71) Applicant: HON HAI PRECISION INDUSTRY CO., LTD., New Taipei (TW)

(72) Inventors: YA-LAN FENG, New Taipei (TW); CHUN-CHENG KO, New Taipei (TW)

(21) Appl. No.: 16/668,040

(22) Filed: Oct. 30, 2019

(30) Foreign Application Priority Data
Jan. 23, 2019 (CN) 201910065296.8

(51) Int. Cl. G02B 7/02; G02B 7/04; G02B 13/00; H04N 5/225

(52) U.S. Cl. CPC G02B 7/021; G02B 7/04; H04N 5/2257; G02B 13/001; H04N 5/2254; G02B 7/022

(57) ABSTRACT

A camera lens to reduce abnormal images by rejecting stray or oblique light before it can reach an image sensor includes a hollow lens barrel, a lens assembly received in the lens barrel, and a light shield assembly received in the lens barrel. The lens assembly includes at least two lenses arranged from object side to image side. The light shield assembly includes light shields, each light shield being sandwiched between adjacent two lenses and defining a through hole. An inner wall of the through hole defines an inclined surface, the inclined surface reflects stray and/or oblique light back towards the object side, thus stray light is eliminated. The disclosure further provides a lens module and an electronic device including the camera lens.

### FIELD

The subject matter herein generally relates to image capture and optical devices.

### BACKGROUND

When a conventional lens is used in a bright environment, light of a specific angle can reach an inner wall of a lens barrel, and then is reflected to an image sensor by the lens barrel. Stray light falling on the image sensor affects an imaging quality.

### BRIEF DESCRIPTION OF THE DRAWINGS

Implementations of the present technology will now be described, by way of embodiments, with reference to the attached figures.

FIG. 1 is a schematic view of an embodiment of a lens module.

FIG. 2 is an exploded diagram of the lens module of FIG. 1.

FIG. 3 is a cross-sectional view taken along line of FIG. 1, and an enlarged view of a circled portion.

FIG. 4 is a cross-sectional view of a light shield assembly of the lens module of FIG. 2, and an enlarged view of a circled portion.

FIG. 5 is an isometric view of an electronic device including the lens module of FIG. 1.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

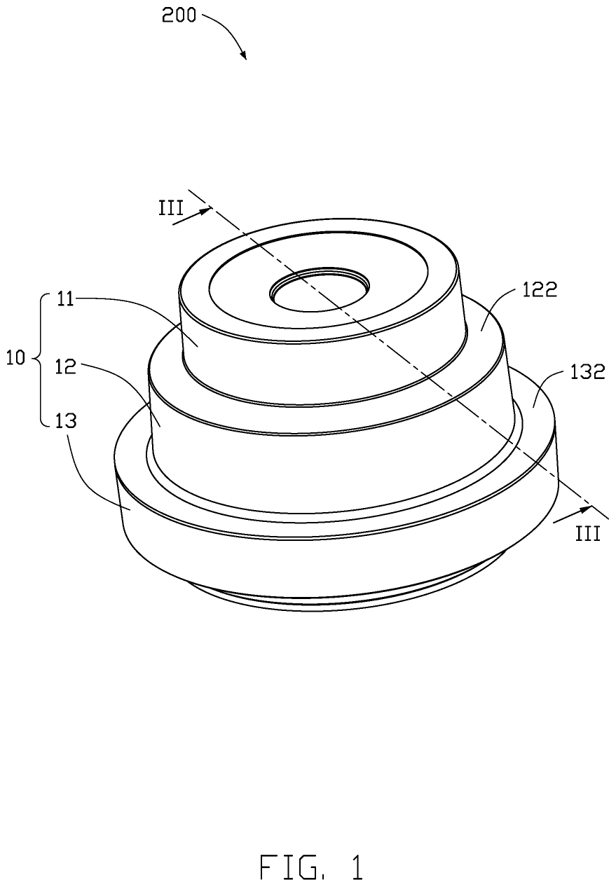

FIGS. 1, 2, and 5 illustrate an embodiment of a camera lens 100. The camera lens 100 includes a lens barrel 10, a lens assembly 20, and a light shield assembly 30.

The lens barrel 10 has a hollow structure. The lens barrel 10 is cylindrical or step-shaped. In one embodiment, the lens barrel 10 is stepped. The lens barrel 10 includes a first lens barrel portion 11, a second lens barrel portion 12, and a third lens barrel portion 13. The second lens barrel portion 12 is connected between the first lens barrel portion 11 and the third lens barrel portion 13. Respective diameters of the first, second, and third lens barrel portions 11, 12, and 13 increase in succession, thus a first step 122 is formed on an end of the second lens barrel portion 12 adjacent to the first lens barrel portion 11, and a second step 132 is formed on end of the third lens barrel portion 13 adjacent to the second lens barrel portion 12. The lens barrel 10 can be assembled (that is, the first, second, and third lens barrel portions 11, 12, and 13 are separate items assembled together) or can be integrally formed. In one embodiment, the first, second, and third lens barrel portions 11, 12, and 13 are integrally formed to form the lens barrel 10. The lens barrel 10 can be made of metal or plastic. In one embodiment, the lens barrel 10 is made of aluminium alloy.

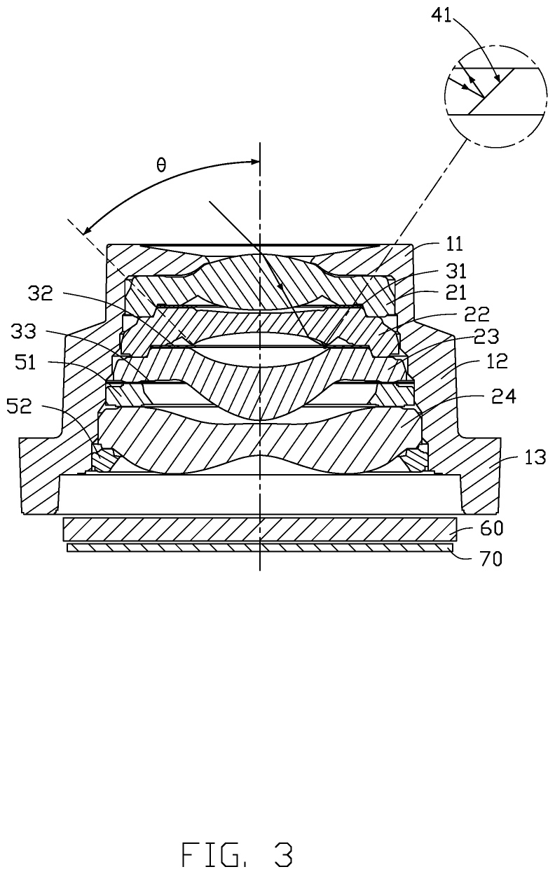

FIG. 3 illustrates that the lens assembly 20 is received in the lens barrel 10. The lens assembly 20 includes a first lens 21, a second lens 22, a third lens 23, and a fourth lens 24 stacked from the object side in direction of an axis of the lens barrel 10. The first lens 21 is received in the first lens barrel portion 11. A part of the second lens 22 is received in the first lens barrel portion 11, and another part of the second lens 22 is received in the second lens barrel portion 12. The third lens 23 is received in the second lens barrel portion 12. A part of the fourth lens 24 is received in the second lens barrel portion 12, and another part of the fourth lens 24 is received in the third lens barrel portion 13. The first, second, third, and fourth lenses 21, 22, 23, and 24 are all made of optical resin, and have a good light transmittance.

The light shield assembly 30 is received in the lens barrel 10. The light shield assembly 30 includes a first light shield 31, a second light shield 32, and a third light shield 33. The first light shield 31 is sandwiched between the first lens 21 and the second lens 22 and is received in the first lens barrel portion 11. The second light shield 32 is sandwiched between the second lens 22 and the third lens 23 and is received in the second lens barrel portion 12. The third light shield 33 is sandwiched between the third lens 23 and the fourth lens 24 and received in the second lens barrel portion 12.

The first, second, third, and fourth lenses 21, 22, 23, and 24 all include an optical portion (not labeled) and a positioning portion (not labeled) surrounding and protruding beyond the optical portion. The first light shield 31 is sandwiched between the optical portions of the first lens 21 and the second lens 22, and is surrounded and positioned by the positioning portion of the first lens 21. The second light shield 32 is sandwiched between the optical portions of the second lens 22 and the third lens 23, and is surrounded and positioned by the positioning portion of the second lens 22. The third light shield 33 is sandwiched between the optical portions of the third lens 23 and the fourth lens 24, and is surrounded and positioned by the second lens barrel portion 12 of the lens barrel 10.

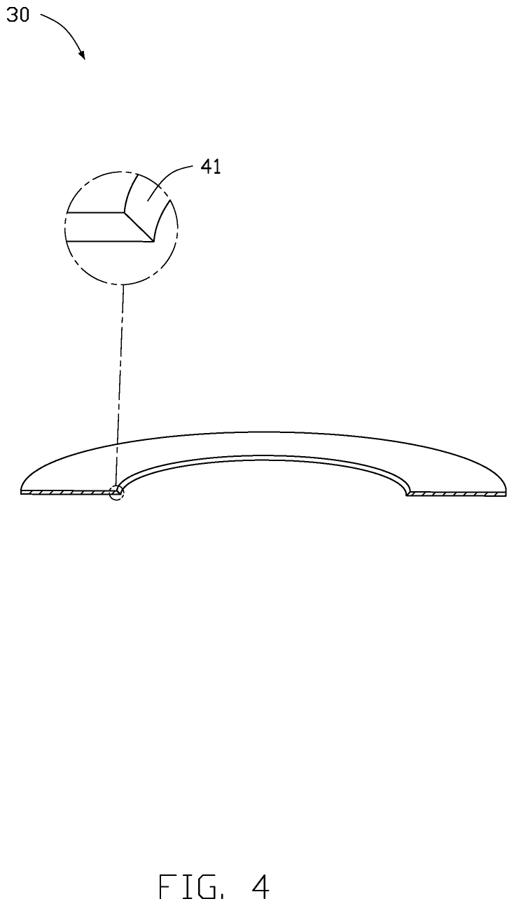

The first, second, and third light shields 31, 32, and 33 are all hollow and circular. The first, second, and third light shields 31, 32, and 33 all define a through hole 40. An inner wall of the through hole 40 defines an inclined surface 41 which is inclined towards object side, that is, the object-side edge of surface 41 forms a circle which is concentric with, but slightly larger than, the circle formed by the image-side edge of surface 41. The inclined surface 41 is configured to change a direction of reflection of incident light reaching the inclined surface 41 (shown in FIGS. 3 and 4). The through hole 40 defines a central axis (shown in FIG. 3). Diameters of cross sections of the through hole 40, perpendicular to the central axis, decrease linearly along a direction from object side to image side. A diameter of a cross section of a first end of the through hole 40 facing the object side is about 1.7 mm, and a diameter of a cross section of a second end of the through hole 40 facing the image side is about 1.66 mm. An angle θ defined between the central axis and the inclined surface 41 is greater than or equal to 45°. In one embodiment, the angle θ is equal to 45°. If the angle θ is too small, the direction of reflection of the incident light reaching the inclined surface 41 will not be back towards the object side. The first, second, and third light shields 31, 32, and 33 include two carbon layers and a PET (polyethylene terephthalate) layer sandwiched between the two carbon layers. The PET layer can reflect light, and the carbon layers can absorb some stray light. When the camera lens 100 is being used, external light will pass through the first lens 21, the second lens 22, and the third lens 23 to reach the inclined surfaces 41, the incident light is reflected back towards the object side by the inclined surfaces 41 of the first light shield 31, the second light shield 32, and the third light shield 33. Stray light falling straight onto an image sensor is largely eliminated, thereby improving the optical quality of the camera lens 100.

In one embodiment, the camera lens 100 further includes a spacer assembly 50. The spacer assembly 50 is received in the lens barrel 10. The spacer assembly 50 includes a first spacer 51 and a second spacer 52. The first spacer 51 is sandwiched between the third light shield 33 and the positioning portion of the fourth lens 24, and is received in the second lens barrel portion 12. The second spacer 52 is arranged on a side of the positioning portion of the fourth lens 24 away from the third light shield 33, and is received in the third lens barrel portion 13. The first spacer 51 is surrounded and positioned by the second lens barrel portion 12 of the lens barrel 10. The second spacer 52 is connected to the fourth lens 24 by adhesive. The first spacer 51 and the second spacer 52 are both hollow and circular. The first spacer 51 is configured to separate the third lens 23 from the fourth lens 24. The second spacer 52 is configured to fix the lens assembly 20 in position in the lens barrel 10.

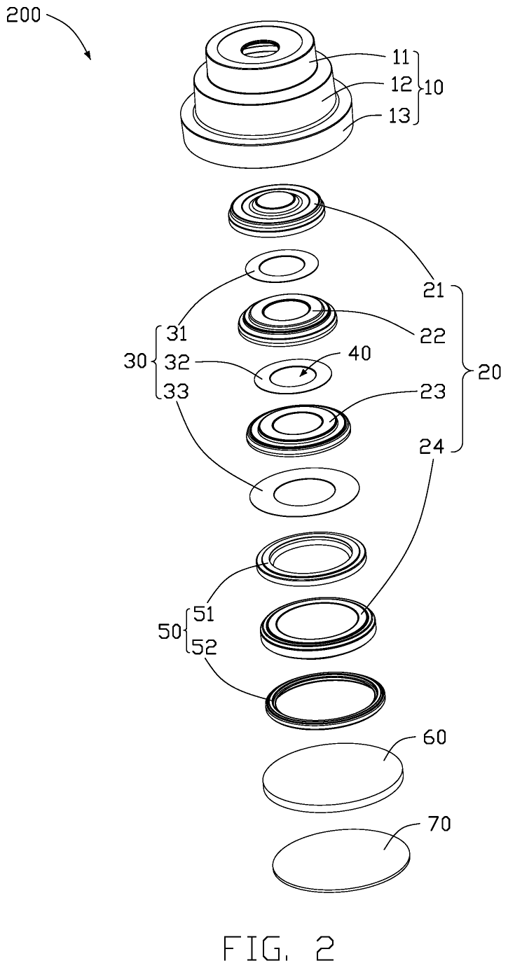

FIGS. 2 and 3 illustrate an embodiment of a lens module 200. The lens module 200 includes an optical filter 60. The optical filter 60 is located outside of the lens barrel 20, corresponds to the lens assembly 20, and is adjacent to a side of the third lens barrel portion 13 away from the second lens barrel 12. The optical filter 60 is configured to filter out incident light having specific wavelengths. The optical filter 60 can be made of plastic or glass with a specific dye added. The optical filter 60 can be circular, rectangular, or other shapes. In one embodiment, the optical filter 60 is circular.

The lens module 200 further includes an image sensor 70. The image sensor is on a side of the optical filter 60 away from the third lens barrel portion 13. The image sensor 70 is configure to receive light from the optical filter 60. The image sensor 70 can be circular, rectangular, or other shapes. In one embodiment, the image sensor 70 is circular.

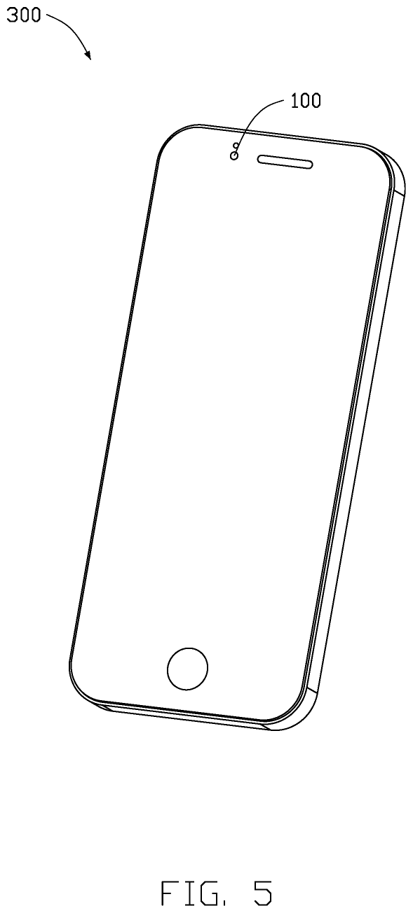

FIG. 5 illustrates an embodiment of an electronic device 300. The electronic device 300 includes the camera lens 100. The electronic device 300 can be any electronic device having imaging capturing functions, such as mobile phones, wearable devices, computer devices, vehicles, or monitoring devices. In one embodiment, the electronic device 300 is a mobile phone.

The configuration of the inclined surfaces 41 of the light shield assembly 30 allows incident light, entering the first light shield 31, the second light shield 32, and the third light shield 33, to be reflected back towards the object side. Thereby the stray light is rejected, the optical quality of the camera lens 100 is improved.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A camera lens comprising:
a hollow lens barrel;
a lens assembly received in the lens barrel, the lens assembly comprising at least two lenses arranged from object side to image side; and
a light shield assembly received in the lens barrel, the light shield assembly comprising at least one light shield;
wherein each of the at least one light shield is sandwiched between adjacent two of the at least two lenses and defines a through hole, an inner wall of the through hole defines an inclined surface inclined towards the object side, the inclined surface is configured to allow incident light to be reflected back towards the object side.

2. The camera lens of claim 1, wherein the light shield assembly comprises a first light shield, a second light shield, and a third light shield, each of the first light shield, the second light shield, and the third light shield defines the through hole, the through hole defines a central axis, an angle defined between the central axis and the inclined surface is greater than or equal to 45°.

3. The camera lens of claim 2, wherein the lens barrel comprises a first lens barrel portion, a second lens barrel portion, and a third lens barrel portion, the second lens barrel portion is connected between the first lens barrel portion and the third lens barrel portion, respective diameters of the first lens barrel portion, the second lens barrel portion, and the third lens barrel portion increase in succession.

4. The camera lens of claim 3, wherein the lens assembly comprises a first lens received in the first lens barrel portion, a second lens, a third lens received in the second lens barrel portion, and a fourth lens, wherein a part of the second lens is received in the first lens barrel portion, another part of the second lens is received in the second lens barrel portion, a part of the fourth lens is received in the second lens barrel portion, another part of the fourth lens is received in the third lens barrel portion.

5. The camera lens of claim 4, wherein the first light shield is sandwiched between the first lens and the second lens and is received in the first lens barrel portion, the second light shield is sandwiched between the second lens and the third lens and is received in the second lens barrel portion, the third light shield is sandwiched between the third lens and the fourth lens and is received in the second lens barrel portion.

6. The camera lens of claim 4, wherein the camera lens further comprises a spacer assembly received in the lens barrel, the spacer assembly comprises a first spacer and a second spacer, the first spacer is sandwiched between the third light shield and the fourth lens and is received in the second lens barrel portion, the second spacer is on a side of the fourth lens away from the third light shield and is received in the third lens barrel portion.

7. The camera lens of claim 1, wherein diameters of cross sections of the through hole decrease linearly along a direction from the object side to the image side, a diameter of a cross section of an end of the through hole facing the object side is approximately 1.7 mm, a diameter of a cross section of an end of the through hole facing the image side is approximately 1.66 mm.

8. A lens module comprising:
a camera lens, the camera lens comprising:
a hollow lens barrel,
a lens assembly received in the lens barrel, the lens assembly comprising at least two lenses arranged from object side to image side, and
a light shield assembly received in the lens barrel, the light shield assembly comprising at least one light shield; and
an optical filter located outside of the lens barrel and corresponding to the lens assembly;
wherein each of the at least one light shield is sandwiched between adjacent two of the at least two lenses and defines a through hole, an inner wall of the through hole defines an inclined surface inclined towards the object side, the inclined surface is configured to allow incident light to be reflected back towards the object side.

9. The lens module of claim 8, wherein the lens module further comprises an image sensor, the image sensor is arranged on a side of the optical filter away from the lens barrel.

10. The lens module of claim 8, wherein the light shield assembly comprises a first light shield, a second light shield, and a third light shield, each of the first light shield, the second light shield, and the third light shield defines the through hole, the through hole defines a central axis, an angle defined between the central axis and the inclined surface is greater than or equal to 45°.

11. The lens module of claim 10, wherein the lens barrel comprises a first lens barrel portion, a second lens barrel portion, and a third lens barrel portion, the second lens barrel portion is connected between the first lens barrel portion and the third lens barrel portion, respective diameters of the first lens barrel portion, the second lens barrel portion, and the third lens barrel portion increase in succession.

12. The lens module of claim 11, wherein the lens assembly comprises a first lens received in the first lens barrel portion, a second lens, a third lens received in the second lens barrel portion, and a fourth lens, wherein a part of the second lens is received in the first lens barrel portion, another part of the second lens is received in the second lens barrel portion, a part of the fourth lens is received in the second lens barrel portion, another part of the fourth lens is received in the third lens barrel portion.

13. The lens module of claim 12, wherein the first light shield is sandwiched between the first lens and the second lens and is received in the first lens barrel portion, the second light shield is sandwiched between the second lens and the third lens and is received in the second lens barrel portion, the third light shield is sandwiched between the third lens and the fourth lens and is received in the second lens barrel portion.

14. The lens module of claim 12, wherein the camera lens further comprises a spacer assembly received in the lens barrel, the spacer assembly comprises a first spacer and a second spacer, the first spacer is sandwiched between the third light shield and the fourth lens and is received in the second lens barrel portion, the second spacer is on a side of the fourth lens away from the third light shield and is received in the third lens barrel portion.

15. The lens module of claim 8, wherein diameters of cross sections of the through hole decrease linearly along a direction from the object side to the image side, a diameter of a cross section of an end of the through hole facing the object side is approximately 1.7 mm, a diameter of a cross section of an end of the through hole facing the image side is approximately 1.66 mm.

16. An electronic device comprising:
a lens module, the lens module comprising a camera lens, the camera lens comprising:
a hollow lens barrel,
a lens assembly received in the lens barrel, the lens assembly comprising at least two lenses arranged from object side to image side, and
a light shield assembly received in the lens barrel, the light shield assembly comprising at least one light shield; and
an optical filter arranged on an outside of the lens barrel and corresponding to the lens assembly;
wherein each of the at least one light shield is sandwiched between adjacent two of the at least two lenses and defines a through hole, an inner wall of the through hole defines an inclined surface inclined towards the object side, the inclined surface is configured to allow incident light to be reflected back towards the object side.
